(19) United States
(12) Patent Application Publication
(10) Pub. No.: US 2026/0246583 A1
(43) Pub. Date: Aug. 20, 2026

(54) MACHINE LEARNING-BASED AIR INTERFACE FOR WIRELESS COMMUNICATION SYSTEMS

(71) Applicant: DeepSig Inc., Arlington, VA (US)

(72) Inventors: Timothy James O'Shea, Arlington, VA (US); James Lansford, Arlington, VA (US); Johnathan Corgan, San Jose, CA (US); Nitin Nair, Washington, DC (US); Daniel DePoy, Alexandria, VA (US); Jake Perazzone, Arlington, VA (US)

(21) Appl. No.: 19/543,507

(22) Filed: Feb. 18, 2026

Related U.S. Application Data
(60) Provisional application No. 63/759,892, filed on Feb. 18, 2025.

(51) Int. Cl. H04L 5/00

(52) U.S. Cl. CPC H04L 5/0048

(57) ABSTRACT

Methods, systems, and apparatus for learned encoding and decoding in wireless networks are disclosed. A method includes receiving one or more radio frequency (RF) signals that encode communications data and do not include pilot data. The RF signals are processed to obtain a representation of the encoded communications data, which is provided to a machine learning model. A decoded version of the encoded communications data is obtained as an output of the machine learning model without reliance on pilot data. A reconstruction of the communications data is then generated based on the decoded version. The techniques facilitate pilot-free transmission modes, such as a zero-demodulation reference signal (DMRS) mode, within existing slot structures to reduce spectral overhead and increase capacity. The machine learning model can be configured using learned constellations or modulation codebooks to perform blind channel estimation and equalization.

### CROSS-REFERENCE TO RELATED APPLICATIONS

This application claims the benefit of U.S. Provisional Application No. 63/759,892, filed Feb. 18, 2025, the contents of which are incorporated by reference herein.

### TECHNICAL FIELD

This specification generally relates to wireless communication systems and, more particularly, to systems and methods that utilize machine learning for learned encoding and decoding of communications data across an air interface.

### BACKGROUND

European Telecommunications Standards Institute (ETSI) Third Generation Partnership Project (3GPP) wireless telecommunications standards, such as fourth generation (4G) and fifth generation New Radio (5G-NR) physical layers, utilize dedicated reference signals and fixed modulation schemes to transmit data across an air interface. In these systems, a transmitter maps data bits to symbols using standard constellations, such as Quadrature Amplitude Modulation (QAM), and embeds specific pilot symbols, such as Demodulation Reference Signals (DMRS), at known time-frequency locations within a resource grid. A receiver relies on these sparse pilot symbols to perform channel estimation and equalization before de-mapping the data symbols. However, the use of dedicated reference signals introduces significant spectral overhead, effectively reducing the available capacity for data transmission. Furthermore, fixed, rectangular QAM constellations are often sub-optimal for specific channel conditions, and the centralization of channel estimation on periodic pilots can lead to pilot contamination and degraded performance in harsh fading environments or high-mobility scenarios.

Existing 5G-NR slot structures typically rely on a non-zero number of DMRS symbols, such as one, two, three, or four symbols per slot, to facilitate coherent detection. This reliance on explicit pilots limits the potential for link margin and throughput improvements that could be achieved by allocating all resource elements to data. While traditional equalization techniques like Minimum Mean Square Error (MMSE) effectively utilize these pilots, they struggle to resolve channel responses when pilot density is reduced or when hardware impairments and non-linear distortions are present. Moreover, traditional systems lack a mechanism for seamless end-to-end optimization of the modulation and encoding scheme across the air interface, resulting in an inability to adapt to site-specific radio environments or to conduct blind channel estimation without dedicated overhead. There is a need for a communication framework that maintains interoperability with existing slot structures while enabling pilot-free transmission and adaptive, learned representations of communications data.

### SUMMARY

This specification describes methods, systems, and apparatus for learned encoding and decoding within a wireless communication framework, such as a 3GPP 5G-NR or sixth generation (6G) air interface. In general, the subject matter involves utilizing machine learning models to facilitate communications that can operate with reduced or zero pilot symbols. By employing learned constellations and neural receiver architectures, the systems can perform blind channel estimation and equalization; this can increase spectral efficiency and capacity compared to traditional 4G or 5G systems that rely on sparse, dedicated reference signals.

Described techniques include providing an adaptive communication interface that maintains interoperability with existing slot structures while enabling pilot-free transmission modes. Advantageous implementations reduce spectral overhead by eliminating or minimizing the use of dedicated demodulation reference signals (DMRS), which can improve both throughput and link margin in various radio environments. Furthermore, the use of learned representations allows the system to adapt to site-specific channel conditions, mitigating issues such as pilot contamination and hardware impairments that often degrade performance in conventional fixed-constellation systems.

In some implementations, a method includes receiving radio frequency (RF) signals from a transmitter, where the signals encode communications data but do not include pilot data. These signals are processed to obtain a representation of the encoded data, which is provided to a machine learning model. The machine learning model generates a decoded version of the communications data without reliance on pilot data, enabling the reconstruction of the original communications data. Other implementations involve a base station determining and indicating learned constellations to a user equipment (UE) through control messages. The base station then receives messages from the UE that encode data based on the learned constellations without including pilot symbols, effectively operating in a zero-DMRS mode.

In some examples, a UE identifies a reference signal parameter in a radio resource configuration message to determine whether a transmission slot is configured for a pilot-free mode. If the parameter indicates zero DMRS symbols, the UE utilizes a learned receiver to equalize data symbols directly. Additionally, the disclosure addresses the exchange of modulation codebooks and neural network weights between network elements to facilitate interoperability. For instance, a transmitter may select a neural modulation codebook learned to facilitate channel estimation and transmit a sequence of symbols over a resource grid devoid of dedicated pilot symbols.

Techniques can include the application of cover sequences to modulation symbols to induce a zero-mean property, enabling blind channel estimation and mitigating inter-cell interference. Techniques can include lifecycle management (LCM) of neural receiver configurations, where a UE can update its machine learning models based on model identifiers, weight transfers, or iterative loss metric feedback. These learned designs can be optimized for specific radio environments through the collection and transmission of channel observation data, allowing for a refined balance between power reduction and capacity improvement.

In general, one innovative aspect of the subject matter described in this specification can be embodied in methods that include the actions of receiving, over a telecommunication link from a transmitter, one or more radio frequency (RF) signals that (i) include communications data, and (ii) do not include pilot data; processing the one or more RF signals to obtain a representation of the communications data; providing the representation of the communications data to a machine learning model; obtaining, as an output of the machine learning model, a decoded version of the communications data, where the machine learning model generates the decoded version of the communications data without reliance on pilot data; and generating, based on the decoded version of the communications data output from the machine learning model, a reconstruction of the communications data. By decoding data without reliance on pilot data, this method facilitates a reduction in spectral overhead, thereby improving total data-carrying capacity.

In another innovative aspect, a method includes the actions of determining, by a base station (BS), one or more learned constellations for a communications session with a user equipment (UE); sending, by the BS, one or more control messages to the UE for the communications session, where the control messages indicate the one or more learned constellations for the communications session without relying on pilot symbols; and receiving, from the UE, one or more messages that (i) include communications data based on the learned constellations indicated by the control messages, and (ii) do not include pilot data. Utilizing learned constellations for communications without relying on pilot symbols mitigates pilot contamination between adjacent sectors while enhancing link margin sensitivity in multipath environments.

In another innovative aspect, a method includes the actions of receiving, from a base station (BS), a radio resource configuration message defining a slot structure for a transmission slot; identifying, from the radio resource configuration message, a reference signal parameter indicating a quantity of demodulation reference signal (DMRS) symbols allocated within the slot structure; determining that the transmission slot is configured for a pilot-free transmission mode when the reference signal parameter indicates zero DMRS symbols; and processing a received signal in the transmission slot using a learned receiver configured to equalize data symbols in the transmission slot without reliance on dedicated reference signals. Configuring a pilot-free transmission mode when a reference signal parameter indicates zero DMRS symbols allows for the dynamic allocation of all resource elements to data, which improves spectral efficiency and overall throughput.

In another innovative aspect, a method includes the actions of selecting, by a transmitter, a neural modulation codebook specifying a mapping of data bits to complex symbol values, where the mapping is learned to facilitate channel estimation; transmitting a control message indicating the selected neural modulation codebook to a receiver; encoding a stream of data bits into a sequence of complex symbols using the selected neural modulation codebook; and transmitting the sequence of complex symbols over an air interface resource grid, where the resource grid is devoid of dedicated pilot symbols for channel estimation. Transmitting data using a neural modulation codebook over a resource grid devoid of dedicated pilot symbols can improve channel capacity by replacing sparse pilots with data-aided learned representations.

In another innovative aspect, a method includes the actions of generating a sequence of modulation symbols using a learned encoding scheme; applying a cover sequence to the sequence of modulation symbols to generate a covered symbol sequence, where the cover sequence is configured to induce a zero-mean property in the covered symbol sequence; mapping the covered symbol sequence to a plurality of orthogonal frequency division multiplexing (OFDM) resource elements in a transmission slot; and transmitting the transmission slot without dedicated demodulation reference signals (DMRS), where the cover sequence enables blind channel estimation by a receiver. Inducing a zero-mean property via a cover sequence enables blind channel estimation, which can increase resilience to time-frequency distortions in harsh fading channels.

In another innovative aspect, a method includes the actions of receiving, from a base station, a Lifecycle Management (LCM) message for a neural receiver configuration; determining, based on the LCM message, an update mode for the neural receiver, where the update mode is selected from a group including: (a) a Model ID mode, where the UE selects a stored neural network model based on an index provided in the LCM message; (b) a Model Transfer mode, where the UE receives neural network weights in the LCM message to configure the neural receiver; and (c) a Feedback-Training mode, where the UE transmits loss metric feedback to the base station to facilitate iterative updates of the neural receiver; and configuring the neural receiver according to the determined update mode to process pilot-free orthogonal frequency division multiplexing (OFDM) symbols. Managing neural receiver configurations through an LCM message can help end-to-end optimization of the modulation and encoding scheme, and can improve long-term link reliability and adaptability.

The foregoing and other implementations can each optionally include one or more of the following features, alone or in combination. In particular, one implementation includes all the following features in combination.

Feature 1: The transmitter includes a user equipment (UE). Processing signals from a UE without reliance on pilot data can reduce the spectral overhead associated with uplink control signals, which can thereby increase the effective uplink throughput for the UE.

Feature 2: Receiving the one or more radio frequency (RF) signals includes receiving the one or more RF signals at an evolved NodeB (eNB), a next generation NodeB (gNB), or 6G next generation NodeB. Utilizing an AI-native base station to decode pilot-free signals can enable the network to support higher user density, e.g., by reclaiming resource elements typically reserved for reference signals. Feature 3: The pilot data includes one or more pilot signals or pilot symbols.

Feature 4: The one or more control messages indicate that the communications session is configured for a pilot-free transmission mode using a cyclic prefix-orthogonal frequency division multiplexing (CP-OFDM) scheme or a discrete Fourier transform-spread-orthogonal frequency division multiplexing (DFT-s-OFDM) scheme. Providing a pilot-free mode within these OFDM schemes can allow the system to maintain interoperability with existing 5G-NR waveforms, e.g., while improving spectral efficiency.

Feature 5: The one or more messages received from the UE are structured according to an orthogonal frequency division multiplexing (OFDM) slot structure including a plurality of OFDM slots, and where each OFDM slot of the plurality of OFDM slots includes encoded communications data and is devoid of pilot symbols. Allocating all resource elements in a slot to encoded data can increase the information rate per hertz, e.g., by eliminating the traditional one-seventh pilot overhead or other overhead reduction.

Feature 6: The pilot symbols include demodulation reference signal (DMRS) symbols, and where the one or more control messages indicate a zero-DMRS mode for the communications session. Operating in a zero-DMRS mode can mitigate pilot contamination between adjacent sectors, e.g., which can enhance link margin sensitivity in interference-limited environments.

Feature 7: When the reference signal parameter indicates a non-zero quantity of DMRS symbols, the UE processes the received signal using the DMRS symbols for channel estimation. Maintaining a fallback to DMRS-based estimation can help ensure robust connectivity and backward compatibility with legacy base stations or during periods of high channel uncertainty.

Feature 8: Actions include receiving an index identifying a modulation codebook from a plurality of stored codebooks, where the learned receiver utilizes the modulation codebook to decode the data symbols. Using a codebook index can enable efficient signaling of complex, learned mappings between bits and symbols, e.g., without the need for frequent transfers of large neural network model files.

Feature 9: The control message includes one of: a codebook index referencing a predefined lookup table shared between the transmitter and the receiver, a definition of neural network weights or parameters, an Open Neural Network Exchange (ONNX) file, or a file including neural network weights or parameters. Providing flexible model sharing mechanisms can allow the system to balance signaling overhead against the need for high-fidelity, site-specific receiver configurations.

Feature 10: The cover sequence is generated based on a seed derived from a Physical Cell Identity (PCI), a Radio Network Temporary Identifier (RNTI), or a user identifier to mitigate inter-cell interference. Deriving the cover sequence seed from unique network identifiers can facilitate pseudo-orthogonality between users, e.g., which can reduce co-channel interference during blind channel estimation.

Feature 11: The cover sequence includes a rotational sequence e^{j·k} or a binary sequence of +1 and −1 values. Applying these specific sequences can induce a zero-mean property that can enable the neural receiver to resolve phase and amplitude responses directly from the data resource elements.

Feature 12: Actions include performing transform precoding on the covered symbol sequence prior to mapping to the plurality of OFDM resource elements to reduce a Peak-to-Average Power Ratio (PAPR). Reducing the PAPR can improve the power amplifier efficiency of the transmitter, e.g., which can extend the battery life of a UE and expand its effective range at the cell edge.

Feature 13: The update mode is the Model ID mode, and where the UE identifies the stored neural network model from a predefined codebook shared between the UE and the base station. Selecting models via a Model ID can enable rapid lifecycle management (LCM) transitions between optimized configurations, such as switching from a high-mobility model to a stationary model.

Feature 14: The update mode is the Model Transfer mode, and where the LCM message includes a container file formatted according to an Open Neural Network Exchange (ONNX) standard or a serialized tensor format or other file that includes one or more neural network weights or parameters. Direct model transfer can allow the network to push custom, high-performance decoders to the UE that are specifically trained for the local multipath profile.

Feature 15: Actions include collecting channel observation data representing a radio environment of the UE and transmitting the channel observation data to the base station prior to receiving the LCM message, where the neural receiver configuration is optimized for the radio environment based on the channel observation data. Utilizing a digital twin approach with site-specific data can enable the air interface to adapt to unique geographic features, e.g., improving link reliability in complex urban environments.

Feature 16: The update mode is the Feedback-Training mode, and where the UE calculates a binary cross-entropy loss or a log-likelihood ratio (LLR) error for a received symbol and transmits said loss or error to the base station. Providing loss metric feedback can facilitate iterative, over-the-air fine-tuning of the end-to-end communication link, e.g., improving throughput even as interference conditions change.

Innovative aspects of the subject matter described in this specification can include: (i) receiving and processing pilot-free radio-frequency signals using a machine learning model to decode communications data without reliance on pilot data; (ii) configuring pilot-free transmission in an OFDM slot structure by indicating learned constellations and/or a zero-DMRS mode through control signaling; (iii) determining, by a UE, whether a slot is pilot-free based on a reference-signal parameter indicating a DMRS quantity, and selecting a learned receiver accordingly; (iv) selecting and signaling a neural modulation codebook (or model definition) for mapping bits to complex symbols in a resource grid devoid of dedicated pilot symbols; (v) applying a cover sequence to induce a zero-mean property to facilitate blind channel estimation; and (vi) managing learned receiver updates through signaling of model identifiers, model transfers, and/or feedback-based training.

The technologies described in this specification can be implemented to realize one or more of the following advantages. First, the use of learned constellations and neural receiver architectures can enable wireless communication with reduced or zero pilot symbols, which can significantly decrease spectral overhead and increase the data-carrying capacity of the air interface. By eliminating or minimizing the use of dedicated demodulation reference signals (DMRS), the system can allocate a larger portion of the resource grid to communications data, which can lead to improvements in both throughput and link margin sensitivity. Second, the machine learning models can facilitate blind channel estimation and equalization, which can allow the system to adapt to site-specific radio environments and mitigate performance degradation caused by multipath fading, hardware impairments, and non-linear distortions. This adaptability can enhance performance in harsh environments, such as urban microcell (UMi) or high-mobility scenarios, where traditional fixed modulation schemes can struggle. Third, the implementation of pilot-free transmission modes can reduce the impact of pilot contamination between cells, which can improve edge performance and overall network reliability. Additionally, the framework can maintain interoperability with existing slot structures and communication standards, such as 4G or 5G.NR, providing a seamless transition from legacy systems to AI-native architectures. The use of lifecycle management (LCM) and online learning loops can allow for dynamic model updates and fine-tuning, which can ensure that the encoding and decoding strategies remain optimized as underlying channel conditions or network interference profiles evolve.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram showing an example of a system for learned encoding and decoding within a wireless communication framework.

FIG. 2 is a diagram showing examples of receiver terminals configured to process pilot-free data resource elements.

FIG. 3 is a chart showing a performance comparison between a pilot-free neural autoencoder and a traditional modulation scheme in a ray-traced urban channel environment.

FIG. 4 is a chart showing a performance comparison between a pilot-free neural autoencoder and a traditional modulation scheme in an urban microcell channel environment.

FIGS. 5-10 are flowcharts of example processes for learned encoding and decoding within a wireless communication framework.

Like reference numbers and designations in the various drawings indicate like elements.

### DETAILED DESCRIPTION

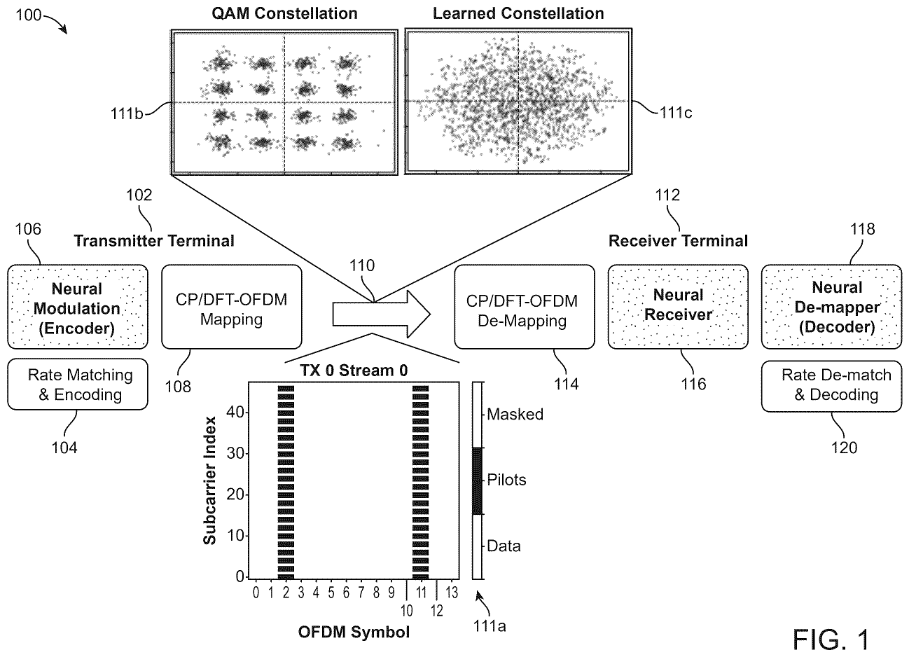

FIG. 1 illustrates an example communication system 100 for learned encoding and decoding within a wireless communication framework, such as a 5G-NR or 6G air interface. As shown, in some implementations, the communication system 100 includes a transmitter 102 and a receiver 112, which can be configured to operate using an autoencoder-based modulation scheme integrated with a physical layer, such as a 5G-NR physical layer. In some implementations, the transmitter 102 corresponds to a user equipment (UE) and the receiver 112 corresponds to a base station (BS), such as an evolved NodeB (eNB) for 4G communications, a 5G next generation NodeB (gNB), or an AI-native 6G next generation NodeB (6GNB). In other implementations, the transmitter 102 can be a BS (e.g., an eNB, a gNB, or a 6GNB) and the receiver 112 can be a UE. The system 100 can further include a mode selection logic that determines whether to process data through a traditional Quadrature Amplitude Modulation (QAM)-based path or an artificial intelligence (AI)-native learned path based on a configuration parameter received in a control message, such as a Radio Resource Control (RRC) message or a Downlink Control Information (DCI) grant.

In some implementations, the BS indicates the activation of the AI-native learned path via a specific Information Element (IE) in an RRC Reconfiguration message, which establishes a zero-DMRS slot configuration for a persistent or semi-persistent schedule. For dynamic scheduling, the BS can utilize a DCI format (e.g., an enhancement of DCI format 0_1 or 1_1) that includes a modulation and reference signal indicator field. This field can be configured to signal a quantity of zero DMRS symbols, effectively triggering the UE to bypass traditional channel estimation and engage the neural receiver 116 for the scheduled physical uplink shared channel (PUSCH) or physical downlink shared channel (PDSCH) resources. By embedding this trigger within the DCI, the system achieves sub-millisecond switching between legacy and AI-native modes, allowing the scheduler to adapt to instantaneous changes in the channel multipath profile or interference environment.

As illustrated in FIG. 1, the transmitter 102 can include a rate matching and encoding module 104, an encoder 106 for neural modulation, and a mapping module 108 for Cyclic Prefix-Orthogonal Frequency Division Multiplexing (CP-OFDM) or Discrete Fourier Transform-spread-Orthogonal Frequency Division Multiplexing (DFT-s-OFDM) mapping. In some implementations, one or more of the rate matching and encoding module 104, encoder 106, and CP/DFT-OFDM mapping module 108 are hardware electronic circuits. In some implementations, one or more of the rate matching and encoding module 104, encoder 106, and CP/DFT-OFDM mapping module 108 are realized as instructions that are programmed in hardware, e.g., as firmware. For example, bits intended for transmission can enter the rate matching and encoding 104, which can perform transport block encoding, add checksums, and split the data into code blocks. The resulting data bits can then pass to the encoder 106, which can utilize a neural modulation scheme to map data bits to complex symbol values.

In some implementations, the encoder 106 maps a set of bits to a block of multiple resource elements (REs) to achieve a block coding gain. For instance, rather than a one-to-one mapping of bits to symbols (e.g., 4 bits per symbol for 16 QAM), the encoder 106 can map a larger block, such as eight bits to two REs, or N bits to M REs (where N and M are integers>0). This sensitivity improvement over traditional QAM methods can be achieved at the modulation block level, allowing the system to scale to more constellation points and achieve higher spectral efficiency. Furthermore, the neural modulation scheme can be learned to compensate or pre-compensate for hardware impairments or non-linear distortions, such as Power Amplifier (PA) non-linearity or other hardware impairments of the transmitter 102. By learning these impairments inherently within the encoder and decoder, the system can reduce the use of high-complexity traditional linearity correction stages. The output of the encoder 106 can then be processed by the mapping 108 to map the symbols to a time-frequency resource grid, which can then be converted into a transmission 110 of radio frequency (RF) signals for transmission over an air interface.

The transmission 110 can be represented in various formats to illustrate the structure and data content of the signals. For example, the transmission 110 can be represented as a resource grid 111a, which shows a subcarrier index on the y-axis and an OFDM symbol index on the x-axis. In the resource grid 111a, different colors or patterns can indicate whether specific resource elements are masked, include pilots (e.g., DMRS), or include data. The communication system 100 can support multiple transmission modes. In a first mode, the transmission 110 can include a traditional QAM constellation 111b, which shows QAM points arranged in a rectangular grid. In a second mode, such as a pilot-free or zero DMRS mode, the transmission 110 can utilize a learned constellation 111c, which can show an irregular distribution of symbols optimized for a specific channel or radio environment.

The receiver 112 can include de-mapping 114 for CP/DFT-s-OFDM de-mapping, a neural receiver 116, a decoder 118 for neural de-mapping, and rate de-matching and decoding 120. In some implementations, one or more of the de-mapping 114 for CP/DFT-s-OFDM de-mapping, the neural receiver 116, the decoder 118 for neural de-mapping, and the rate de-matching and decoding 120 are hardware electronic circuits. In some implementations, one or more of the de-mapping 114 for CP/DFT-s-OFDM de-mapping, the neural receiver 116, the decoder 118 for neural de-mapping, and the rate de-matching and decoding 120 are realized as instructions that are programmed in hardware, e.g., as firmware. One or more of the de-mapping 114 for CP/DFT-s-OFDM de-mapping, the neural receiver 116, the decoder 118 for neural de-mapping, and the rate de-matching and decoding 120 can be software routines, such as Central Processing Unit (CPU), Tensor Processing Unit (TPU), Neural Processing Unit (NPU), or Graphics Processing Unit (GPU) instructions.

Upon receiving the transmission 110, the de-mapping 114 can convert the received RF signals back into a representation of the resource grid. This representation can be provided to the neural receiver 116, which can be configured to perform channel estimation and equalization. In some examples, the neural receiver 116 can estimate channel properties, such as a frequency response H and a noise standard deviation σ, to equalize the symbols. The output of the neural receiver 116 can be provided to the decoder 118, which can map the equalized symbols back into data bits or soft-bit log-likelihood ratios (LLRs). The rate de-matching and decoding 120 can perform forward error correction (FEC) decoding and error checks to reconstruct the original communications data.

The configuration of the neural receiver 116 and decoder 118 may be managed via a Lifecycle Management (LCM) message. The LCM message can indicate an update mode such as a Model ID mode, a Model Transfer mode (e.g., using an Open Neural Network Exchange (ONNX) file, set of model weights, or architecture definitions or parameters), or a Feedback-Training mode. In some implementations, the LCM message enables the wireless communication network to adapt to dynamic radio environments by dynamically switching between update modes or configuring specific parameters within a selected mode. For example, the LCM message can include a configuration for a specific neural network architecture, such as a number of layers, activation functions, or a quantization level (e.g., 8-bit integer vs. 16-bit floating point), to balance decoding accuracy with the computational constraints of the UE. When operating in the Model ID mode, the base station can transmit a message that triggers the UE to switch between different pre-stored models optimized for specific mobility scenarios, such as a high-speed rail model or a stationary indoor model, based on real-time channel measurements. In the Model Transfer mode, the base station can use the LCM message to provide incremental weight updates or “delta-weights” rather than a full model definition, which can reduce the signaling overhead on the downlink. In some cases, the base station can use the LCM message to provide a full model definition. In the Feedback-Training mode, the UE can be configured to transmit the loss metric feedback according to a specific periodicity or upon the occurrence of a triggering event, such as a signal quality metric falling below a predefined threshold. These LCM operations can facilitate an end-to-end optimization of the air interface by helping both the transmitter and the learned receiver remain synchronized in their modulation and equalization strategies, even as the underlying channel conditions or network interference profiles evolve.

The communication system 100 can leverage learned constellations alongside existing 5G or similar 4G slot structures on top of CP-OFDM and/or DFT-s-OFDM schemes. This can allow for the integration of learned communications as an evolution of existing standards. For example, the OFDM slot structure can use existing DMRS-based reference signals with a traditional MMSE equalizer, or it can leverage the neural receiver 116 based on these reference signals. Alternatively, the communication system 100 can operate in a pilot-free “zero DMRS” mode, where all resource elements in the resource grid 111a are allocated to data symbols using the learned constellation 111c. In this pilot-free mode, bits can be encoded into resource elements such that the receiver 112 can learn to equalize them directly without reliance on dedicated reference signals. This can occur when the encoder 106 introduces a structural bias or asymmetry on a per-element basis within the learned constellation 111c, providing sufficient information for the neural receiver 116 to resolve the channel response, such as the time domain impulse response or frequency domain amplitude and phase response, of the transmission channel.

The communication system 100 can also utilize a cover sequence, such as a binary sequence of +1 and −1 values or a rotational sequence (e.g., e^{j·k}), which can be applied prior to channel estimation and equalization to allow the constellation to learn a zero-mean solution. The cover sequence can be generated based on a seed derived from a Physical Cell Identifier (PCI) or a user identifier to mitigate inter-cell interference and/or pilot contamination. Utilizing a cover sequence can enable the re-use of an autoencoder scheme between multiple users and multiple sectors by providing pseudo-orthogonality between the transmissions. Utilizing such zero-DMRS or reduced DMRS modes can increase capacity by reducing overhead and allowing additional data allocation at the same spectral efficiency. Furthermore, the learned designs can be fine-tuned for specific deployment scenarios, such as Urban Microcell (UMi) or Urban Macrocell (UMa) environments, to optimize performance metrics like Bit Error Rate (BER) or Block Error Rate (BLER). This optimization can involve minimizing binary cross-entropy between log-likelihood ratios (LLRs) and ground truth bits or optimizing the mutual information in the soft-bits produced at the output of the decoder network.

In some implementations, the system 100 manages Phase Tracking Reference Signals (PTRS), e.g., separately or in conjunction with the pilot-free transmission mode. For high-frequency deployments, such as those in Frequency Range 2 (FR2) or Frequency Range 4 (FR4), the neural receiver 116 can be configured to utilize sparse PTRS symbols to track and compensate for common phase error (CPE) and phase noise while still operating without DMRS. In some cases, the neural receiver 116 can be trained to perform joint phase noise compensation and data decoding, e.g., treating phase noise as a learned impairment. In this AI-native configuration, the base station can signal a zero-PTRS configuration alongside the zero-DMRS configuration, allowing the learned receiver to resolve phase rotations based on the structural bias of the learned constellations 111c. In some cases, the system can reclaim spectral resources typically reserved for phase tracking. Furthermore, the learned designs can be fine-tuned for specific deployment scenarios, such as Urban Microcell (UMi) or Urban Macrocell (UMa) environments, e.g., to optimize performance metrics like Bit Error Rate (BER) or Block Error Rate (BLER). This optimization can involve minimizing binary cross-entropy between log-likelihood ratios (LLRs) and ground truth bits or optimizing the mutual information in the soft-bits produced at the output of the decoder network.

Coordination between the transmitter 102 and receiver 112 can be accomplished by sharing model weights or by transmitting a neural modulation codebook that specifies the encoder's input-to-output mappings in a compact lookup table. This codebook-based approach can allow a transmitter to implement the learned modulation scheme by performing a discrete mapping of bits to complex symbol values (e.g., I and Q) without necessarily running a neural network in real-time. For higher-order blocks, such as mapping 8 bits to 2 REs, the codebook could scale to 256 entries, with each entry providing IQ values for multiple resource elements. Additionally, a system scheduler can leverage the sensitivity gain provided by the pilot-free neural autoencoder to adjust the information rate. By targeting a specific block error rate (e.g., 10% BLER), the scheduler can select a higher Modulation and Coding Scheme (MCS) for a given Signal-to-Noise Ratio (SNR), which can further increase the total throughput of the system.

In some implementations, the communication system 100 can utilize a Radio Access Network (RAN) Digital Twin and an online learning framework to optimize the autoencoder-based modulation scheme for specific deployment scenarios. This iterative optimization process can facilitate data collection and online learning to achieve site-specific performance gains. For example, to optimize performance for a single UE, a single cell, or a specific geographic region, the BS can perform training on a channel representation that is highly representative of a target area. This can be achieved using the RAN Digital Twin, which can generate accurate channel models based on extracted channel responses from the target area or through emulated channel environments using calibrated ray tracing, Radio Frequency Neural Radiance Field (RF-NeRF), or Radio Frequency Gaussian Splatting (RF-GS) methods. These models can be shared between the UE and the BS by transferring model definitions, such as Open Neural Network Exchange (ONNX) files, serialized tensor formats, or other files that include model weights or architecture parameters. In some examples, these definitions are encapsulated within an Abstract Syntax Notation One (ASN.1) information element or carried via another network protocol such as Radio Resource Control (RRC) or Non-Access Stratum (NAS) signaling.

In some implementations, the communication system 100 performs online learning where the UE and the BS coordinate training after deployment by jointly training over the air interface. This can be accomplished via a Feedback-Training mode utilizing an iterative training feedback loop. In this mode, the UE can collect channel observation data representing its specific radio environment and transmit this data to the BS. The BS, or a connected management entity, can use this data to perform iterative weight updates to the neural receiver 116 or the encoder 106.

To facilitate two-sided training over a live telecommunications link without a shared ground truth, the transmitter can optionally add perturbational noise to transmitted symbols. The receiver can then calculate a loss metric, such as a binary cross-entropy loss or an LLR error, for the received symbols. This loss metric can be returned to the transmitter end of the link, such as within an ASN.1 information element or another control message, where an optimization process, such as stochastic gradient descent (SGD), can be performed. The weights of the machine learning models (e.g., the encoder 106 or neural receiver 116) can be updated based on the relationship between the applied perturbational noise and the resulting impact on the loss metric. This iterative fine-tuning can allow the network to prioritize end-to-end design for specific fading or Doppler conditions, which can result in improved capacity and link margin in the final deployed system. The system 100 can utilize sensing-native features to identify adjacent network allocations or radio technologies, enabling the scheduler to adjust parameters and streamline the use of frequency bands, e.g., in FR1, FR2, or FR3, with shared usage.

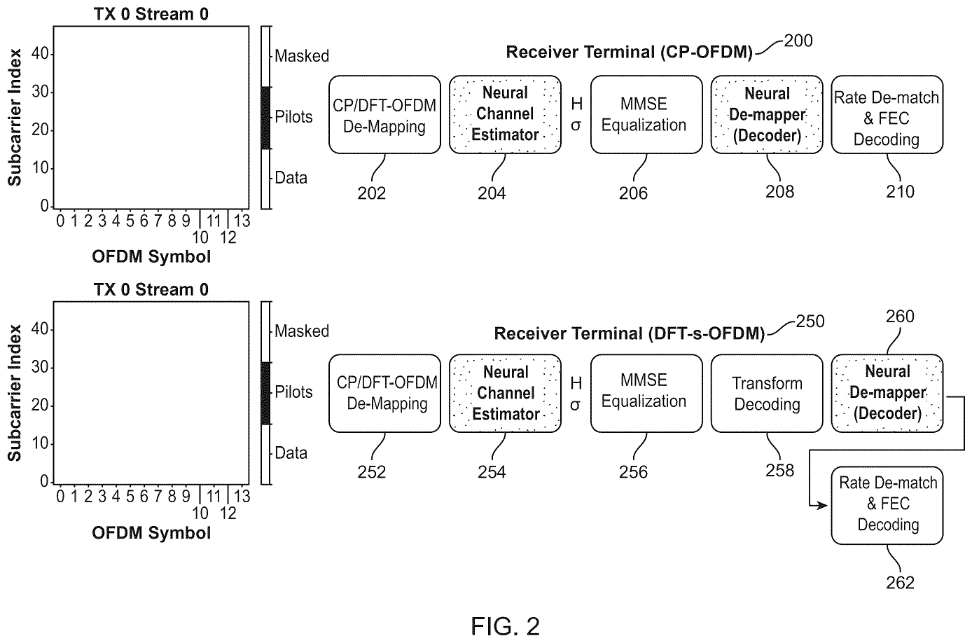

FIG. 2 illustrates a receiver terminal 200 and a receiver terminal 250 that utilize CP-OFDM or DFT-s-OFDM (or Single Carrier-Frequency Division Multiple Access (SC-FDMA)) to process pilot-free data resource elements, according to one or more implementations. The receiver terminal 200 and the receiver terminal 250 are implementations of the receiver 112 of FIG. 1, sharing common architectural elements for processing received signals. The receiver terminal 200 includes de-mapping 202, a neural channel estimator 204, MMSE equalization 206, a neural de-mapper (decoder) 208, and rate de-match and FEC decoding 210. In operation, the de-mapping 202 provides a frequency-domain representation of the received signals to the neural channel estimator 204. The neural channel estimator 204 determines channel properties, such as a frequency response H and a noise standard deviation σ, which are provided to the MMSE equalization 206. The equalized symbols are then processed by the neural de-mapper 208 and the rate de-match and FEC decoding 210 to reconstruct the original data bits.

One or more components of FIG. 2 can correspond to at least part of the functional blocks shown in FIG. 1. For example, the de-mapping 202 can be an implementation of the de-mapping 114, e.g., converting the time-domain transmission 110 into a representation of a resource grid 111a. The neural channel estimator 204 can be a specific implementation of the neural receiver 116, e.g., utilizing machine learning to resolve channel responses without reliance on dedicated reference signals. In some implementations, one or more of the neural channel estimator 204 and the MMSE equalization 206 form the neural receiver 116, e.g., where the machine learning model estimates channel parameters that are subsequently used by a traditional equalizer. The neural receiver 116 can be an end-to-end neural network equalizer that replaces both blocks to output symbol estimates directly.

The neural de-mapper 208 can be an implementation of the decoder 118, e.g., mapping symbols to soft-bit LLRs. In some implementations, the neural de-mapper 208 is a compact neural network trained to recognize learned constellations 111c. In some cases, the neural de-mapper 208 can be replaced by a closed-form max-log-map decoder that references a shared modulation codebook. The rate de-match and FEC decoding 210 can be an implementation of the rate de-matching and decoding 120, e.g., performing parity checks and transport block reconstruction. These modules can be realized as dedicated hardware electronic circuits, as firmware instructions programmed in hardware, or as software modules executed by one or more processors.

The receiver terminal 250 includes de-mapping 252, a neural channel estimator 254, MMSE equalization 256, transform decoding 258, a neural de-mapper (decoder) 260, and rate de-match and FEC decoding 262. The receiver terminal 250 operates similarly to the receiver terminal 200, but is configured for DFT-s-OFDM by including the transform decoding 258 between the MMSE equalization 256 and the neural de-mapper 260. In these implementations, transform precoding at the transmitter and the corresponding transform decoding 258 at the receiver terminal 250 can optionally be applied to allow for solutions with a further reduced PAPR. The learned receiver terminal 250 may be trained with transform precoding in the loop such that the autoencoder mapping is designed to have good properties for both channel estimation/equalization and data transmission with knowledge of the specific transform utilized. In some implementations, the system 100 may utilize distinct neural network models for CP-OFDM and DFT-s-OFDM modes to prevent the models from converging to sub-optimal solutions due to differing loss functions associated with frequency-domain and time-domain features. The selection between these modes can be indicated via control signaling from a scheduler. The receiver can use control signaling to determine whether to apply the transform decoding 258.

In some implementations, the training for these receiver architectures can be conducted directly in the frequency domain representation or while including the transform to the time-domain for time-domain channel simulation. These channel simulations may include Gaussian noise, Rayleigh fading, or additional channel models such as Clustered Delay Line (CDL), Tapped Delay Line (TDL), UMa, UMi, or ray-traced simulations. The learned receiver terminal 200, 250 may utilize a range of different architectures. For example, the receiver terminal 200, 250 may take in the Orthogonal Frequency Division Multiplexing (OFDM) resource grid, such as after cover sequence removal, and output estimates for the received symbols directly using an end-to-end neural network equalizer. In other cases, the receiver terminal 200, 250 may be fused with the decoder to output LLRs or error correction codewords directly from the resource grid. This training approach allows the autoencoder mapping to be designed with knowledge of the specific transform utilized, ensuring robustness in both frequency-domain and time-domain signal processing environments.

Compact neural networks can be used for channel estimation where the neural network estimates properties such as the frequency response H or noise variance, which are then used by a zero forcing (ZF), MMSE, successive interference cancellation (SIC), or interference rejection combining (IRC) algorithm to recover symbols. In some implementations, these neural networks can be replaced with closed-form alternatives, such as computing symbol-to-LLR decoding using traditional log-map or max-log-map mappings based on a selected codebook. The neural channel estimator 204, 254 can exploit properties such as a bias of the constellation elements or relationships between resource elements in closed form to obtain a channel estimate. These functions can be learned end-to-end to conduct the constellation design and neural network design for processing simultaneously, optimizing the link for site-specific conditions through the use of digital twins or online fine-tuning.

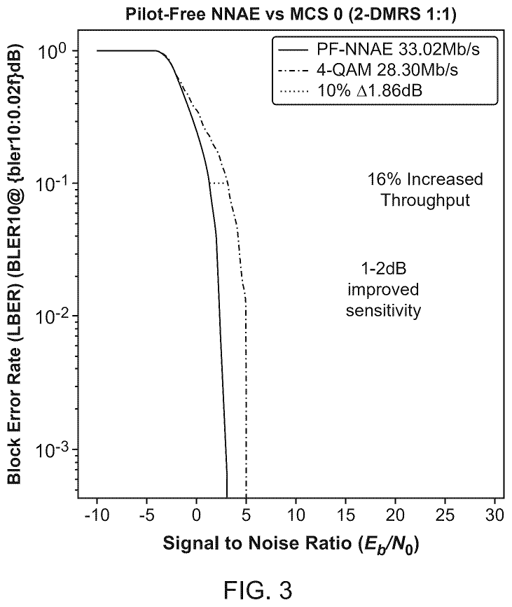

FIG. 3 illustrates a performance comparison between a pilot-free neural network autoencoder (NNAE) and a traditional 4-QAM modulation scheme within a ray-traced urban channel environment. As shown in the block error rate (BLER) versus signal-to-noise ratio (Eb/N0) chart, the pilot-free NNAE achieves technical improvements in both throughput and link margin sensitivity. Specifically, the pilot-free NNAE demonstrates a sensitivity improvement of approximately 1-2 dB compared to the standard modulation scheme, as indicated by the shift in the BLER curve toward lower Eb/N0 values. This performance gain can be realized through the implementation of the neural receiver 116 of FIG. 1, e.g., which when configured as the receiver terminal 200 of FIG. 2, utilizes a neural channel estimator 204 to recover data from the pilot-free resource grid 111a.

FIG. 3 highlights that the disclosed techniques provide an approximate 16% increase in throughput. This improvement can be achieved by reducing spectral overhead through the elimination of dedicated reference signals. In the illustrated comparison, the pilot-free NNAE replaces a configuration using two demodulation reference signal (DMRS) symbols per slot (e.g., a 2-DMRS 1:1 or 1:2 pattern), such that the resource elements previously reserved for pilots are utilized for communications data. By processing the received signals using a learned receiver that conducts channel estimation and equalization simultaneously across all resource elements, the system mitigates pilot contamination and improves edge performance in harsh multipath environments, such as the illustrated urban channel. This transition to a zero-DMRS mode enables the system to maintain or exceed the performance of traditional QAM-based schemes while maximizing the data-carrying capacity of the air interface.

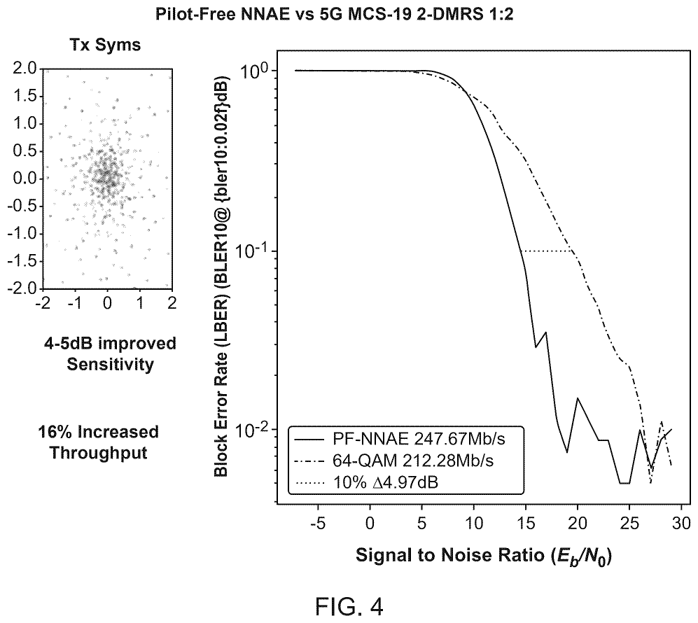

FIG. 4 illustrates a performance comparison between a pilot-free neural autoencoder (NNAE) and a traditional 5G MCS-19 modulation scheme within an urban microcell (UMi) channel environment characterized by harsh multipath fading. As shown in the block error rate (BLER) versus signal-to-noise ratio (Eb/N0) chart, the pilot-free NNAE achieves technical improvements in both data-carrying capacity and link margin sensitivity. Specifically, the pilot-free NNAE demonstrates a sensitivity improvement of approximately 4-5 dB compared to the standard 64-QAM modulation scheme used in 5G MCS-19, as indicated by the significant leftward shift of the BLER curve. These results demonstrate the efficacy of the end-to-end learned path of FIG. 1, e.g., when processing learned constellations 111c using the receiver terminal 250 of FIG. 2. In the example of the receiver terminal 250, the transform decoding 258 can be utilized to maintain performance in multipath environments.

FIG. 4 highlights that the implementation of a pilot-free mode provides an approximate 16% increase in throughput. This improvement is obtained by reducing spectral overhead through the elimination of the 2-DMRS 1:2 pilot pattern, where the resource elements previously allocated to demodulation reference signals are instead utilized for communications data. In the illustrated example, the pilot-free NNAE attains a throughput of 247.67 Mb/s, whereas the traditional 64-QAM scheme attains 212.28 Mb/s under the same spectral conditions. By utilizing a learned receiver 116 to conduct channel estimation and equalization simultaneously across all resource elements in the resource grid 111a, the system enhances high Signal-to-Interference-plus-Noise Ratio (SINR) data rates and provides increased resilience to the time-frequency distortions prevalent in urban microcell deployments. This transition to a zero-DMRS mode, as indicated by a reference signal parameter in a radio resource configuration message, can enable the air interface to maximize spectral efficiency while maintaining robust performance in multipath environments.

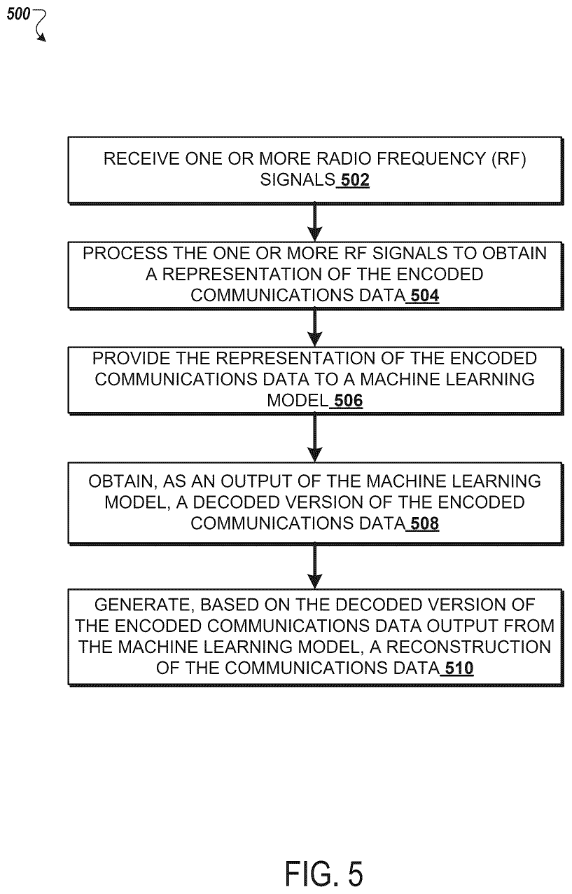

FIG. 5 is a flowchart of an example process 500 for learned encoding and decoding within a wireless communication framework. For convenience, the process 500 will be described as being performed by a system of one or more computers, located in one or more locations, and programmed appropriately in accordance with this specification. For example, a receiver system, e.g., the receiver 112 of FIG. 1, appropriately programmed, can perform the process 500.

The process 500 includes receiving one or more radio frequency (RF) signals (502). The receiving can include receiving one or more RF signals, over a telecommunication link from a transmitter, that (i) encode communications data, and (ii) do not include pilot data. In some cases, the de-mapping 114 can receive the transmission 110 of RF signals and convert the signals into a representation of a resource grid 111a that is devoid of dedicated demodulation reference signals.

In some cases, the transmitter includes a user equipment (UE). For example, the receiver 112 can act as a base station that receives uplink transmissions from one or more UEs.

In some examples, receiving the one or more RF signals includes receiving the one or more RF signals at an evolved NodeB (eNB), a next generation NodeB (gNB), or 6G next generation NodeB. The base station can process these signals to reconstruct data transmitted from a mobile device or another network node.

In some cases, the pilot data includes one or more pilot signals or pilot symbols. For instance, the pilot data can include dedicated reference signals that the system can optionally omit to achieve pilot-free communications.

The process 500 includes processing the one or more RF signals to obtain a representation of the encoded communications data (504). For example, the de-mapping 114 can perform CP-OFDM or DFT-s-OFDM de-mapping to generate a frequency-domain representation of the resource grid from the received RF signals.

The process 500 includes providing the representation of the encoded communications data to a machine learning model (506). For example, the de-mapping 114 can provide the representation of the resource grid to the neural receiver 116 or a neural channel estimator 204.

The process 500 includes obtaining, as an output of the machine learning model, a decoded version of the encoded communications data (508). In some cases, the machine learning model generates the decoded version of the encoded communications data without reliance on pilot data. For example, the neural receiver 116 or the decoder 118 can process the equalized symbols to generate soft-bit log-likelihood ratios (LLRs) or a decoded bitstream without using information from explicit pilot symbols.

The process 500 includes generating, based on the decoded version of the encoded communications data output from the machine learning model, a reconstruction of the communications data (510). For example, the rate de-matching and decoding 120 can perform forward error correction (FEC) decoding and parity checks on the output of the machine learning model to reconstruct the original transport block.

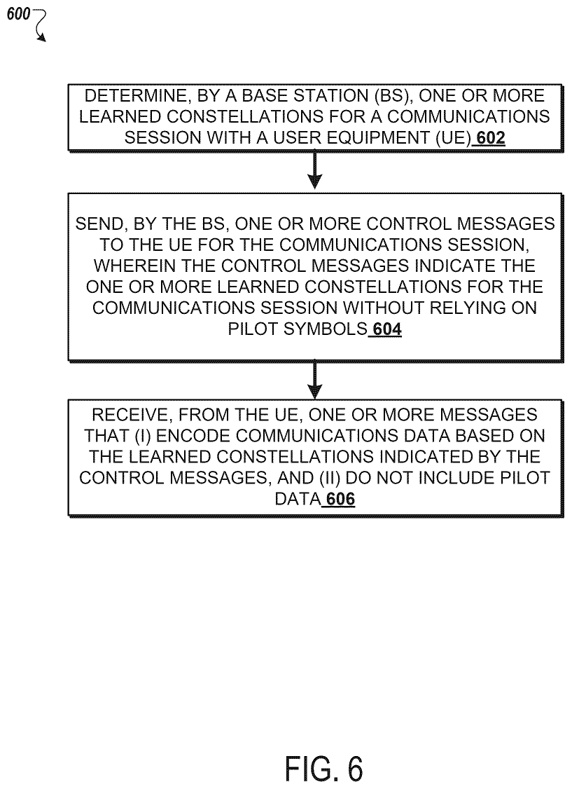

FIG. 6 is a flowchart of an example process 600 for learned encoding and decoding within a wireless communication framework. For convenience, the process 600 will be described as being performed by a system of one or more computers, located in one or more locations, and programmed appropriately in accordance with this specification. For example, a base station system, e.g., implemented using the receiver 112 of FIG. 1, appropriately programmed, can perform the process 600.

The process 600 includes determining, by a base station (BS), one or more learned constellations for a communications session with a user equipment (UE) (602). For example, the receiver 112 can determine a learned constellation 111c, e.g., that is optimized for site-specific channel conditions, such as an urban microcell environment.

The process 600 includes sending, by the BS, one or more control messages to the UE for the communications session, wherein the control messages indicate the one or more learned constellations for the communications session without relying on pilot symbols (604). For example, the receiver 112 can transmit a Radio Resource Control (RRC) message or an Abstract Syntax Notation One (ASN.1) information element that includes a neural modulation codebook or an index identifying a modulation codebook from a plurality of stored codebooks.

In some cases, the process 600 can include indicating that the communications session is configured for a pilot-free transmission mode using a cyclic prefix-orthogonal frequency division multiplexing (CP-OFDM) scheme or a discrete Fourier transform-spread-orthogonal frequency division multiplexing (DFT-s-OFDM) scheme. For example, the one or more control messages can include a configuration parameter that instructs the UE to utilize a specific OFDM waveform basis while operating in an AI-native learned path.

The process 600 includes receiving, from the UE, one or more messages that (i) encode communications data based on the learned constellations indicated by the control messages, and (ii) do not include pilot data (606). For example, the receiver 112 can receive a transmission 110 where the data is mapped to resource elements in a resource grid 111a that is devoid of dedicated demodulation reference signals.

In some cases, the process 600 can include receiving one or more messages structured according to an orthogonal frequency division multiplexing (OFDM) slot structure comprising a plurality of OFDM slots, where each OFDM slot of the plurality of OFDM slots comprises encoded communications data and is devoid of pilot symbols. For example, the system 100 can allocate all resource elements in a slot to communications data, effectively increasing the data-carrying capacity by utilizing resource elements previously reserved for reference signals.

In some cases, the process 600 can include indicating a zero-DMRS mode for the communications session where the pilot symbols comprise demodulation reference signal (DMRS) symbols. For example, a reference signal parameter in a radio resource configuration message can indicate a quantity of zero DMRS symbols, triggering the receiver 112 to process the received signals using a learned receiver configured to perform blind channel estimation and equalization.

In some cases, the process 600 can include a BS identifying a quantity of DMRS symbols as zero within a reference signal parameter of a radio resource configuration message sent to the UE. For example, the receiver 112 can receive a configuration parameter that indicates a zero-DMRS mode for a communications session, allowing the UE to utilize a learned receiver to equalize data symbols directly from a resource grid 111a. This configuration can enable the reconstruction of communications data without reliance on traditional pilots, increasing spectral efficiency by allocating resource elements previously reserved for reference signals to data transmission.

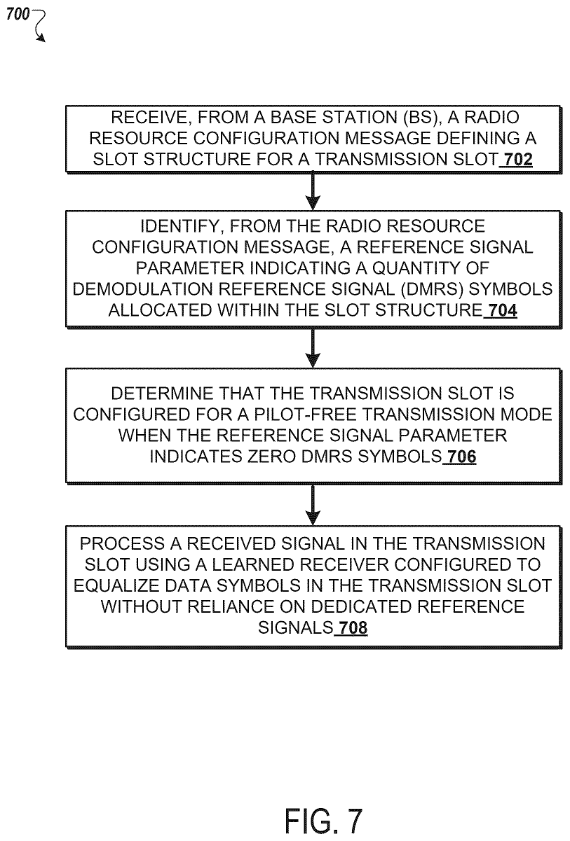

FIG. 7 is a flowchart of an example process 700 for learned encoding and decoding within a wireless communication framework. For convenience, the process 700 will be described as being performed by a system of one or more computers, located in one or more locations, and programmed appropriately in accordance with this specification. For example, a user equipment (UE) system, e.g., implemented using the transmitter 102 or receiver 112 of FIG. 1, appropriately programmed, can perform the process 700.

The process 700 includes receiving, from a base station (BS), a radio resource configuration message defining a slot structure for a transmission slot (702). For example, the receiver 112 can receive a configuration parameter in a control message, such as a Radio Resource Control (RRC) message, which defines the allocation of time-frequency resources within a resource grid 111a.

The process 700 includes identifying, from the radio resource configuration message, a reference signal parameter indicating a quantity of demodulation reference signal (DMRS) symbols allocated within the slot structure (704). For example, the receiver 112 can identify a parameter that specifies a DMRS quantity, such as one, two, three, or four symbols per slot as used in traditional 5G-NR slot structures.

The process 700 includes determining that the transmission slot is configured for a pilot-free transmission mode when the reference signal parameter indicates zero DMRS symbols (706). For example, the mode selection logic of the receiver 112 can determine whether to process data through a traditional path or an AI-native learned path by detecting that the reference signal parameter indicates a zero-DMRS mode for a communications session.

In some cases, the process 700 can include, when the reference signal parameter indicates a non-zero quantity of DMRS symbols, the UE processes the received signal using the DMRS symbols for channel estimation. For example, the receiver terminal 200 can utilize existing DMRS-based reference signals to facilitate coherent detection when the network indicates a traditional transmission mode. This allows the system to maintain interoperability with legacy slot structures while providing the flexibility to switch to learned receiver architectures as channel conditions evolve.

The process 700 includes processing a received signal in the transmission slot using a learned receiver configured to equalize data symbols in the transmission slot without reliance on dedicated reference signals (708). For example, the neural receiver 116 can estimate channel properties, such as a frequency response H and a noise standard deviation σ, to equalize data symbols directly from a resource grid 111a devoid of dedicated pilot symbols.

In some cases, the process 700 can include receiving an index identifying a modulation codebook from a plurality of stored codebooks, wherein the learned receiver utilizes the modulation codebook to decode the data symbols. For example, the receiver 112 can receive an index within an ASN.1 information element that identifies a neural modulation codebook, allowing the neural de-mapper 208 to map equalized symbols back into data bits or soft-bit log-likelihood ratios (LLRs). This codebook-based approach allows the receiver to implement the learned modulation scheme by referencing discrete mappings of bits to complex symbol values stored in a compact lookup table.

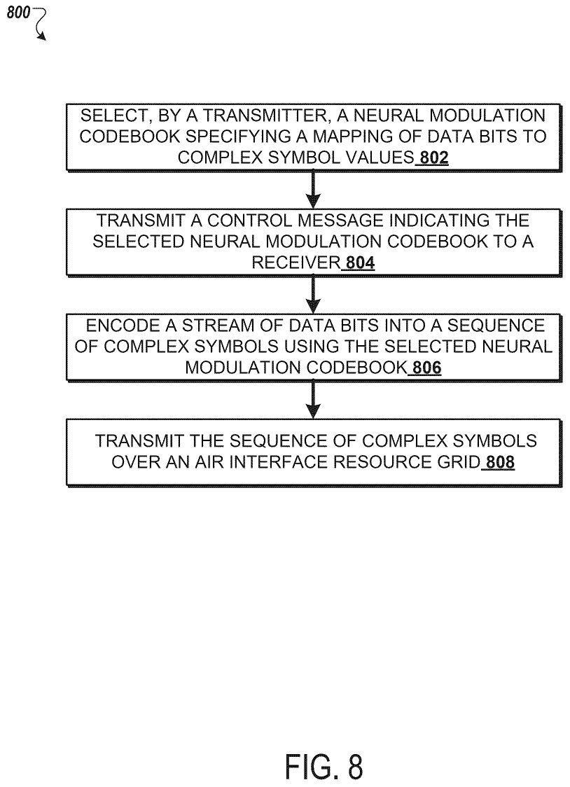

FIG. 8 is a flowchart of an example process 800 for learned encoding and decoding within a wireless communication framework. For convenience, the process 800 will be described as being performed by a system of one or more computers, located in one or more locations, and programmed appropriately in accordance with this specification. For example, a transmitter system, e.g., the transmitter 102 of FIG. 1, appropriately programmed, can perform the process 800. In some implementations, a transmitter system corresponding to a user equipment (UE) performs the process 800. In some implementations, a transmitter system corresponding to a base station (BS) performs the process 800.

The process 800 includes selecting, by a transmitter, a neural modulation codebook specifying a mapping of data bits to complex symbol values, e.g., where the mapping is learned to facilitate channel estimation (802). For example, the rate matching and encoding module 104 and encoder 106 can select a neural modulation codebook 111c that introduces a structural bias or asymmetry to enable a receiver to resolve a channel response without dedicated pilots.

In some cases, the control message comprises one of: a codebook index referencing a predefined lookup table shared between the transmitter and the receiver, a definition of neural network weights or parameters, an Open Neural Network Exchange (ONNX) file, or a file including neural network weights or parameters. For example, the transmitter 102 can access a stored neural modulation codebook identified by an index within an ASN.1 information element or receive a full model definition file to configure its encoder 106 for a specific radio environment.

The process 800 includes transmitting a control message indicating the selected neural modulation codebook to a receiver (804). For example, the transmitter 102 can transmit a Radio Resource Control (RRC) message or Downlink Control Information (DCI) grant to the receiver 112 to synchronize the mapping scheme used for the upcoming transmission.

The process 800 includes encoding a stream of data bits into a sequence of complex symbols using the selected neural modulation codebook (806). For example, the encoder 106 can perform a discrete mapping of bits to complex IQ symbol values for a block of multiple resource elements, such as mapping 8 bits to 2 resource elements, based on the selected codebook.

The process 800 includes transmitting the sequence of complex symbols over an air interface resource grid, e.g., where the resource grid is devoid of dedicated pilot symbols for channel estimation (808). For example, the mapping module 108 can map the resulting complex symbols to a resource grid 111a that is in a zero-DMRS mode, where all resource elements in a transmission slot are allocated to data symbols.

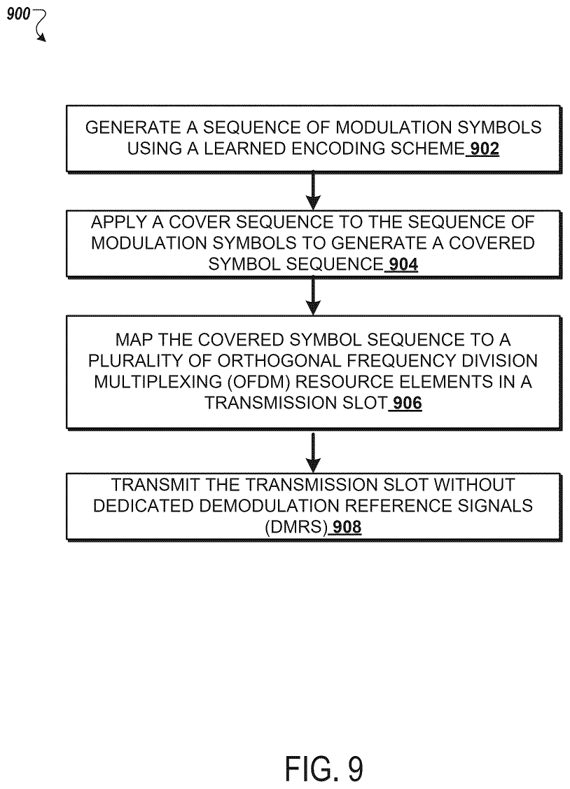

FIG. 9 is a flowchart of an example process 900 for transmitting data in a wireless network. For convenience, the process 900 will be described as being performed by a system of one or more computers, located in one or more locations, and programmed appropriately in accordance with this specification. For example, a transmitter system, e.g., the transmitter 102 of FIG. 1, appropriately programmed, can perform the process 900. In some implementations, a transmitter system corresponding to a user equipment (UE) performs the process 900. In some implementations, a transmitter system corresponding to a base station (BS) performs the process 900.

The process 900 includes generating a sequence of modulation symbols using a learned encoding scheme (902). For example, the rate matching and encoding module 104 and encoder 106 can utilize a neural modulation scheme to map data bits to complex symbol values based on an autoencoder architecture.

The process 900 includes applying a cover sequence to the sequence of modulation symbols to generate a covered symbol sequence (904). In some cases, the cover sequence is configured to induce a zero-mean property in the covered symbol sequence. For example, applying a cover sequence can involve multiplying the sequence of modulation symbols by a series of rotational values or binary values prior to mapping module 108 processing to ensure the resulting constellation exhibits a zero-mean distribution.

In some cases, the process 900 can include the cover sequence being generated based on a seed derived from a Physical Cell Identity (PCI), a Radio Network Temporary Identifier (RNTI), or a user identifier, e.g., to mitigate inter-cell interference. For example, the transmitter 102 can derive a pseudo-random seed from the PCI assigned to the base station to ensure that the covered symbol sequence is pseudo-orthogonal to transmissions from adjacent sectors. This mitigation of inter-cell interference can allow for the reuse of the same autoencoder-based resource grid allocations across different cells. By utilizing a unique user identifier in the seed derivation, the system can distinguish between multiple users in the same sector during blind channel estimation.

In some cases, the process 900 can include the cover sequence comprises a rotational sequence e^{j·k} or a binary sequence of +1 and −1 values. For example, the system 100 can apply a rotational cover sequence of unit amplitude with varying phase k to shift the mean of the learned constellation to zero. Alternatively, a binary sequence of +1 and −1 can be applied to the sequence of modulation symbols to induce the zero-mean property. This specific mathematical structure of the cover sequence enables the neural receiver 116 to perform blind channel estimation by resolving the phase and amplitude shifts introduced by the transmission channel against the known properties of the covered symbol sequence.

The process 900 includes mapping the covered symbol sequence to a plurality of orthogonal frequency division multiplexing (OFDM) resource elements in a transmission slot (906). For example, the mapping module 108 can map the complex symbol values to specific subcarrier and symbol indexes within a resource grid 111a.

The process 900 includes transmitting the transmission slot without dedicated demodulation reference signals (DMRS) (908). In some cases, the cover sequence enables blind channel estimation by a receiver. The transmitter 102 can transmit a transmission 110 where the resource grid can be in a zero-DMRS mode, e.g., allowing the receiver 112 to utilize the structural bias of the learned constellation and the zero-mean property of the cover sequence to recover the channel response.

In some cases, the process 900 can include performing transform precoding on the covered symbol sequence prior to mapping to the plurality of OFDM resource elements. This transform precoding can be utilized to reduce a peak-to-average power ratio (PAPR) of the transmitted signal. For example, by applying a discrete Fourier transform (DFT) to the sequence of modulation symbols before the mapping 906, the transmitter can generate a DFT-s-OFDM waveform that exhibits lower power fluctuations compared to a standard CP-OFDM waveform. This reduction in PAPR can enhance the efficiency of power amplifiers at the transmitter, particularly for transmissions from a UE at the edge of a cell. The learned encoding scheme can be optimized specifically for use with transform precoding, ensuring that the structural properties required for blind channel estimation are maintained through the transform and subsequent frequency-domain mapping.

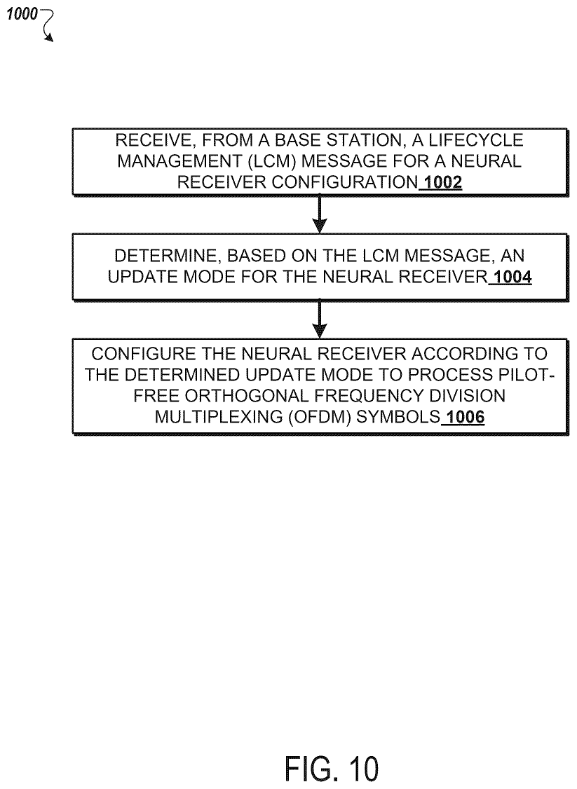

FIG. 10 is a flowchart of an example process 1000 for learned encoding and decoding within a wireless framework. For convenience, the process 1000 will be described as being performed by a system of one or more computers, located in one or more locations, and programmed appropriately in accordance with this specification. For example, a user equipment (UE), e.g., the transmitter 102 or receiver 112 of FIG. 1, appropriately programmed, can perform the process 1000.

The process 1000 includes receiving, from a base station, a Lifecycle Management (LCM) message for a neural receiver configuration (1002). For example, the receiver 112 can receive a configuration for a specific neural network architecture, such as a number of layers, activation functions, or a quantization level, to balance decoding accuracy with computational constraints.

The process 1000 includes determining, based on the LCM message, an update mode for the neural receiver (1004). In some cases, the update mode is selected from a group consisting of: (a) a Model ID mode, where the UE selects a stored neural network model based on an index provided in the LCM message; (b) a Model Transfer mode, where the UE receives neural network weights in the LCM message to configure the neural receiver; and (c) a Feedback-Training mode, where the UE transmits loss metric feedback to the base station to facilitate iterative updates of the neural receiver. For example, the mode selection logic can determine whether to trigger a switch between pre-stored models or to process incremental “delta-weights” provided in the LCM message.

In some cases, the process 1000 can include determining, based on the LCM message, an update mode for the neural receiver, where the update mode is the Model ID mode, and where the UE identifies the stored neural network model from a predefined codebook shared between the UE and the base station. For example, when operating in the Model ID mode, the base station can transmit an index that triggers the UE to switch between different pre-stored models optimized for specific mobility scenarios, such as a high-speed rail model or a stationary indoor model, e.g., based on real-time channel measurements.

In some cases, the process 1000 can include determining, based on the LCM message, an update mode for the neural receiver, where the update mode is the Model Transfer mode, and where the LCM message includes a container file, e.g., formatted according to an Open Neural Network Exchange (ONNX) standard or a serialized tensor format. The file can include one or more neural network weights or parameters. In the Model Transfer mode, the base station can use the LCM message to provide a full model definition or a serialized container file that the UE can use to configure the neural receiver 116.

In some cases, the process 1000 can include collecting channel observation data representing a radio environment of the UE and transmitting the channel observation data to the base station prior to receiving the LCM message, where the neural receiver configuration is optimized for the radio environment based on the channel observation data. For example, the UE can collect channel observation data representing its specific radio environment and transmit this data to the base station, allowing the base station to perform site-specific training and return an optimized configuration via the LCM message.

In some cases, the process 1000 can include determining, based on the LCM message, an update mode for the neural receiver, where the update mode is the Feedback-Training mode, and where the UE calculates a binary cross-entropy loss or a log-likelihood ratio (LLR) error for a received symbol and transmits said loss or error to the base station. For example, in the Feedback-Training mode, the UE can be configured to transmit loss metric feedback according to a specific periodicity or upon the occurrence of a triggering event to facilitate an end-to-end optimization of the air interface.

The process 1000 includes configuring the neural receiver according to the determined update mode to process pilot-free orthogonal frequency division multiplexing (OFDM) symbols (1006). For example, the neural receiver 116 can be updated with new weights or a new model architecture to perform blind channel estimation and equalization on a resource grid 111a that is devoid of dedicated reference signals.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, which is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, over a telecommunication link from a transmitter, one or more radio frequency (RF) signals that (i) encode communications data, and (ii) do not include pilot data;
processing the one or more RF signals to obtain a representation of the encoded communications data;
providing the representation of the encoded communications data to a machine learning model;
obtaining, as an output of the machine learning model, a decoded version of the encoded communications data, wherein the machine learning model generates the decoded version of the encoded communications data without reliance on pilot data; and
generating, based on the decoded version of the encoded communications data output from the machine learning model, a reconstruction of the communications data.

2. The method of claim 1, wherein the transmitter comprises a user equipment (UE).

3. The method of claim 1, wherein receiving the one or more radio frequency (RF) signals comprises receiving the one or more RF signals at an evolved NodeB (eNB), a next generation NodeB (gNB), or 6G next generation NodeB.

4. The method of claim 1, wherein the pilot data comprises one or more pilot signals or pilot symbols.

5. A method comprising:
determining, by a base station (BS), one or more learned constellations for a communications session with a user equipment (UE);
sending, by the BS, one or more control messages to the UE for the communications session, wherein the control messages indicate the one or more learned constellations for the communications session without relying on pilot symbols; and
receiving, from the UE, one or more messages that (i) encode communications data based on the learned constellations indicated by the control messages, and (ii) do not include pilot data.

6. The method of claim 5, wherein the one or more control messages indicate that the communications session is configured for a pilot-free transmission mode using a cyclic prefix-orthogonal frequency division multiplexing (CP-OFDM) scheme or a discrete Fourier transform-spread-orthogonal frequency division multiplexing (DFT-s-OFDM) scheme.

7. The method of claim 6, wherein the one or more messages received from the UE are structured according to an orthogonal frequency division multiplexing (OFDM) slot structure comprising a plurality of OFDM slots, and wherein each OFDM slot of the plurality of OFDM slots comprises encoded communications data and is devoid of pilot symbols.

8. The method of claim 7, wherein the pilot symbols comprise demodulation reference signal (DMRS) symbols, and wherein the one or more control messages indicate a zero-DMRS mode for the communications session.

9. A method performed by a user equipment (UE) in a wireless communication network, the method comprising:
receiving, from a base station (BS), a radio resource configuration message defining a slot structure for a transmission slot;
identifying, from the radio resource configuration message, a reference signal parameter indicating a quantity of demodulation reference signal (DMRS) symbols allocated within the slot structure;
determining that the transmission slot is configured for a pilot-free transmission mode when the reference signal parameter indicates zero DMRS symbols; and
processing a received signal in the transmission slot using a learned receiver configured to equalize data symbols in the transmission slot without reliance on dedicated reference signals.

10. The method of claim 9, wherein, when the reference signal parameter indicates a non-zero quantity of DMRS symbols, the UE processes the received signal using the DMRS symbols for channel estimation.

11. The method of claim 9, further comprising receiving an index identifying a modulation codebook from a plurality of stored codebooks, wherein the learned receiver utilizes the modulation codebook to decode the data symbols.

12. A method of wireless communication, the method comprising:
selecting, by a transmitter, a neural modulation codebook specifying a mapping of data bits to complex symbol values, wherein the mapping is learned to facilitate channel estimation;
transmitting a control message indicating the selected neural modulation codebook to a receiver;
encoding a stream of data bits into a sequence of complex symbols using the selected neural modulation codebook; and
transmitting the sequence of complex symbols over an air interface resource grid, wherein the resource grid is devoid of dedicated pilot symbols for channel estimation.

13. The method of claim 12, wherein the control message comprises one of: a codebook index referencing a predefined lookup table shared between the transmitter and the receiver, a definition of neural network weights or parameters, an Open Neural Network Exchange (ONNX) file, or a file including neural network weights or parameters.

14. A method of transmitting data in a wireless network, the method comprising:
generating a sequence of modulation symbols using a learned encoding scheme;
applying a cover sequence to the sequence of modulation symbols to generate a covered symbol sequence, wherein the cover sequence is configured to induce a zero-mean property in the covered symbol sequence;
mapping the covered symbol sequence to a plurality of orthogonal frequency division multiplexing (OFDM) resource elements in a transmission slot; and
transmitting the transmission slot without dedicated demodulation reference signals (DMRS), wherein the cover sequence enables blind channel estimation by a receiver.

15. The method of claim 14, wherein the cover sequence is generated based on a seed derived from a Physical Cell Identity (PCI), a Radio Network Temporary Identifier (RNTI), or a user identifier to mitigate inter-cell interference.

16. The method of claim 14, wherein the cover sequence comprises a rotational sequence e^{j¿} or a binary sequence of +1 and −1 values.

17. A method performed by a user equipment (UE) in a wireless network, the method comprising:
receiving, from a base station, a Lifecycle Management (LCM) message for a neural receiver configuration;
determining, based on the LCM message, an update mode for the neural receiver, wherein the update mode is selected from a group consisting of:
(a) a Model ID mode, wherein the UE selects a stored neural network model based on an index provided in the LCM message;
(b) a Model Transfer mode, wherein the UE receives neural network weights in the LCM message to configure the neural receiver; and
(c) a Feedback-Training mode, wherein the UE transmits loss metric feedback to the base station to facilitate iterative updates of the neural receiver; and
configuring the neural receiver according to the determined update mode to process pilot-free orthogonal frequency division multiplexing (OFDM) symbols.

18. The method of claim 17, wherein the update mode is the Model ID mode, and wherein the UE identifies the stored neural network model from a predefined codebook shared between the UE and the base station.

19. The method of claim 17, wherein the update mode is the Model Transfer mode, and wherein the LCM message comprises a container file formatted according to an Open Neural Network Exchange (ONNX) standard or a serialized tensor format or other file that includes one or more neural network weights or parameters.

20. The method of claim 17, further comprising:
collecting channel observation data representing a radio environment of the UE; and
transmitting the channel observation data to the base station prior to receiving the LCM message, wherein the neural receiver configuration is optimized for the radio environment based on the channel observation data.

21. The method of claim 17, wherein the update mode is the Feedback-Training mode, and wherein the UE calculates a binary cross-entropy loss or a log-likelihood ratio (LLR) error for a received symbol and transmits said loss or error to the base station.
